(19) United States
(12) Patent Application Publication
(10) Pub. No.: US 2006/0217266 A1
(43) Pub. Date: Sep. 28, 2006

(54) Supporting plate for ink receiving member and ink jet printer incorporating the same

(75) Inventors: Hidehiko Komatsu, Nagano (JP); Kazuhisa Takeda, Nagano (JP)

Correspondence Address: LADAS & PARRY, 26 WEST 61ST STREET, NEW YORK, NY, 10023, US

(73) Assignee: SEIKO EPSON CORPORATION

(21) Appl. No.: 11/377,623

(22) Filed: Mar. 16, 2006

(30) Foreign Application Priority Data
Mar. 17, 2005 (JP) 2005-076871

(51) Int. Cl. B41M 5/24

(52) U.S. Cl. 503/227

(57) ABSTRACT

A plate member is formed with a through hole. A first face is adapted to support an ink receiving member thereon. At least one of a projection and a recess is formed on an inner face of the through hole such that a first end thereof is made flush with the first face.

### BACKGROUND OF THE INVENTION

The present invention relates to a supporting plate for ink receiving member and an ink jet printer incorporating the same.

In an ink jet recording system also, marginless printing is performed like silver halide photograph. In the marginless printing, it is necessary to set an entire surface of a recording sheet as an image region without leaving a non-image region (margin) at a peripheral edge of the recording sheet. For the marginless printing, ink drops are continuously ejected from a recording head toward the surface of the recording sheet and even at the outside of the edge thereof, so that an appropriate image can be formed at the entire surface of the recording sheet including the edge thereof. The mechanical principle of the related-art marginless printing will be described with reference to the accompanying drawings. In this specification, “downward” or “upward” relative to a printer represent respectively downward or upward in the gravity direction when printing is performed. As is the case with the above, “below” or “above” relative to the printer represent below or above in the gravity direction when printing is performed.

As shown in FIGS. 1(A) to 2, an ink jet recording apparatus 10 includes a recording head 13 and a platen (not shown) disposed below the recording head 13 and opposed to the recording head 13.

The recording head 13 is mounted on a carriage 14 which can be reciprocally moved along a guide shaft 12 which extends in a primary scanning direction (i.e. a width direction of a recording sheet 11 or a direction of an arrow B in FIGS. 1(A) to 1(B)). The recording sheet 11 is transported by a sheet feeding mechanism (not shown) so as to pass between the recording head 13 and the platen in a secondary scanning direction (a direction of an arrow A in FIGS. 1(A) to 2).

When the leading end 11a of the recording sheet 11 is transported to below the recording head 13, as shown in FIGS. 1(A) and FIG. 2, printing of the leading end 11a is performed. Namely the recording head 13 reciprocally moving in the primary scanning direction ejects ink drops toward the recording sheet 11 to perform the printing. In such a case, in order to perform the printing without leaving a margin at the leading end 11a of the recording sheet, ink drops 19 are ejected even to the outside of the leading end 11a of the recording sheet 11. The ink drops 19 ejected to the outside of the recording sheet 11 are directly attached to the ink receiving member 30 provided with the platen and forming an ink receiving region 31, so that the ink drops 19 penetrate into the ink receiving member 30 ink.

After the printing of the leading end of the recording sheet 11 is completed, the recording sheet 11 is transported in the secondary scanning direction and the printing of the central area of the recording sheet 11 is performed. In the printing of the central area also, in order to perform the printing without leaving the margins at the side edges on both sides of the recording sheet 11, as shown in FIG. 1(B), the ink drops 19 are ejected even to the outside of the side edge 11b of the recording sheet 11. The ink drops 19 ejected to the outside are directly attached to the ink receiving member 30 provided with the platen and trapped. After the printing of the central area of the recording sheet 11 is completed, the recording sheet 11 is transported in the secondary scanning direction and the printing of the trailing end 11c of the recording sheet 11 is performed. In the printing of the trailing end 11c also, in order to perform the printing without leaving the margin at the trailing end of the recording sheet 11, as shown in FIG. 1(C), the ink drops 19 are ejected even to the outside of the trailing end 11c of the recording sheet 11. The ink drops 19 ejected to the outside are directly attached to the ink receiving member 30 provided with the platen and trapped.

As shown in FIGS. 1(A) to 2, in order to perform the marginless printing, the ink drops 19 are ejected even to the outside of the recording sheet 11. So as to prevent the back face of the recording sheet 11 from being contaminated by the ink drops 10 ejected to the outside of the recording sheet 11, the ink receiving member must be provided with the platen.

As shown in FIG. 3 the printing mechanism includes a carriage 4 on which ink cartridges 2, 3 and a recording head 4A are mounted, and a platen 5 disposed opposite to the moving path of the carriage 4. The printing mechanism further includes, at both sides of the platen 5, first sheet holding rollers 6 disposed in an upstream side of the recording head 4A relative to the secondary scanning direction and second sheet holding rollers 7 disposed in a downstream side of the recording head 4A relative to the secondary scanning direction.

As shown in FIGS. 4 and 5, openings 5a, 5b, 5c are provided in the platen 5, and an ink receiving member 20 is disposed below the platen 5. The opening 5a serves as a window for guiding the ink drops toward the ink receiving member 20 so as to prevent the ink drops from adhering to the surface of the platen 5 and from generating ink mist during the printing of the leading end of a recording sheet P. The opening 5b and the opening 5c as well as the opening 5a serve as windows for guiding the ink drops toward the trapping member 20 during the printing of the side edges on both sides and of the trailing end of a recording sheet P, respectively. Namely, all of the ink drops ejected to the outside of the recording sheet P pass through the openings 5a, 5b, 5c so as to be received directly in the ink receiving member 20. Meanwhile, the recording sheet P is transported while the back face of the recording sheet P is kept in contact with the surface of the platen 5. The ink receiving member 20 therefore must be disposed at the height where the back face of the recording sheet P is not brought into contact with the ink receiving member 20.

As shown in FIG. 5, the ink receiving member 20 is supported by a supporting member 8 provided with openings 8a. A waste ink tank 9 is disposed below the supporting member 8. The ink temporarily trapped in the ink receiving member 20 is gradually guided into the waste ink tank 9 through the openings 8a and absorbed and accumulated in an absorbing member usually provided with the waste ink tank 9.

Generally, the platen 5 and the supporting member 8 for the ink receiving member 20 are integrally molded with synthetic resin, so as to form a supporting plate for supporting the transported recording sheet and the ink receiving member.

As shown in FIGS. 6 to 8, a outer peripheral frame 52 constitutes four side walls of the supporting plate 51. The bottom wall 81 is formed with through holes 82a to 82h, the ink receiving member 20 is brought into contact with an upper face 81A of the bottom wall 81 to be supported.

A central table 53 is formed on and projected from the upper face 81A of the bottom wall 81. An upper face 53A of the central table 53 and the upper face 52A of the outer peripheral frame 52 are brought into contact with the back face of the transported recording sheet P so as to serve as the platen. Therefore, the upper face 53A of the central table 53 and the upper face 52A of the outer peripheral frame 52 are adjusted in height so that they are made flush with each other (see FIG. 8).

The ink receiving member 20, as shown in FIG. 7, has a central opening 21. The size of the central opening 21 is larger than that of the outer periphery of the central table 53 of the supporting plate 51. So when the ink receiving member 20 is accommodated in the supporting plate 51, as shown in FIG. 8, the central table 53 projects upward from the central opening 21. In addition, the depth to the bottom wall 81 is greater than the thickness of the ink receiving member 20 so that the ink receiving member 20 is not brought into contact with the back face of the recording sheet P. Further, the ink receiving member 20 is accommodated so as to completely cover the entirety of the respective through holes 82a to 82h. Thus, the ink temporarily trapped in the ink receiving member 20 is gradually guided through the through holes 82a to 82h to the waste ink tank 9 (see FIG. 5), and absorbed and accumulated in the absorbing member usually provided in the waste ink tank 9.

However, in the related-art supporting plate, the ink temporarily trapped in the ink receiving member is difficult to be transferred from the through holes into the waste ink tank. Further, in the case where a pigment ink is used in order to improve the keeping quality of a printed matter; since the ink receiving member is usually formed with a porous material (e.g. polyurethane foam), when the pigment ink penetrates into the porous material, only solvent component of the pigment swiftly penetrates/diffuses or evaporates and solid component of the pigment is condensed. Thus, the fluidity of the ink is decreased so that the ink becomes difficult to be transferred from the ink receiving member to the waste ink tank.

Further, in the case of the ink receiving member having an ink receiving layer and an ink diffusing layer, a material used as the ink diffusing layer has higher absorbency than that of the ink receiving layer so that the ink can be swiftly transferred from the ink receiving layer to the ink diffusing layer. On the other hand, such an ink diffusing layer with high ink absorbency usually accumulates the ink well. Therefore, the ink becomes difficult to be transferred from the ink receiving member to the waste ink tank.

As described above, in the case where the pigment ink is used as the ink or where the material with the high ink absorbency is used as ink diffusing layer in the ink receiving member, the ink is difficult to be transferred smoothly from the ink receiving member to the waste ink tank. As a result, the ink is accumulated in the ink receiving member up to the limit of the holding-power of the ink receiving member, and the ink absorbing capability is decreased. In such a state, it the ink is further ejected from the recording head into the ink receiving member, the ink is not absorbed in the ink receiving member but exists on the upper face (overflows). Because of such a overflowed ink, the ink may be eventually attached to the back face of the recording sheet, or otherwise the ink may be transferred from the back face of the recording sheet to the platen surface so that the back face of another recording sheet is contaminated by the ink. In order to prevent these phenomena, it is necessary to replace the ink receiving member frequently.

### SUMMARY OF THE INVENTION

It is therefore an object of the invention to provide a supporting plate for ink receiving member, which enables ink to be smoothly transferred from an ink receiving member into a waste ink tank, thereby permitting the ink receiving member to be used for a long time.

In order to attain the above described object, according to the invention, there is provided a plate member formed with a through hole comprising:

a first face adapted to support an ink receiving member thereon; and

at least one of a projection and a recess formed on an inner face of the through hole such that a first end thereof is made flush with the first face.

[Claim 2]

a cross-sectional shape of the through hole in a direction parallel to the first face may be one of:

(1) a polygon which all of internal angles are narrow angles;

(2) a curved figure which is a set of arcs in which all of tangential lines are circumscribed; and

(3) a complex form which is a combination of a part of the polygon identified in item (1) and a part of the curved figure identified in item (2).

A cross-sectional shape of the first end in a direction parallel to the first face may be one of a triangle, a quadrangle, a semi-circle and a semi-ellipse.

The plate member may further comprises:

a second face which is opposite to the first face, wherein a second end of the projection is sharpened at the vicinity of the second face.

The second end may be projected from the second face.

The plate member may further comprises;

a second face which is opposite to the first face, wherein the recess connects the first face and the second face.

The polygon may be a rectangle.

The curved figure may be an ellipse.

The complex form may be a combined figure comprising a rectangle and two semi-circles integrated to short sides of the rectangle.

According to the invention, there is also provided a recording apparatus comprising:

a plate member formed with a through hole;

at least one of a projection and a recess formed on an inner face of the through hole such that a first end thereof is made flush with a first face of the plate member;

a recording head operable to eject ink; and

an ink receiving member adapted to receive the ink and supported by the first face of the plate member, the ink receiving member comprising a first layer having a first absorbency and a second layer which is being in contact with the first layer and having a second absorbency higher than the first absorbency.

The ink may be pigment ink.

In this specification, the above and below positional relationship (e.g. “above”, “below”, “upper face” or “lower face”) represent above and below relationship respectively in the gravity direction only in the state where the supporting plate is provided in a printer and printing is performed by the printer. It does not limit the positional relationship in other states (e.g. the states where the supporting plate is carried or set up alone). “Back face” and “bottom” also represent the above and below positional relationship respectively.

In the supporting plate, each of the through holes has at least one of the projection and recess so that the ink temporarily trapped in the porous ink receiving member is smoothly ejected from the though-opening to the waste ink tank so as to prevent accumulation of the ink on the ink receiving member. Thus, it is possible to effectively delay a phenomenon that pigment particles on the surface of the ink receiving member gradually grow to project upward from the opening of the platen, thereby permitting the ink receiving member to be used for a long time.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1(A) is a schematic perspective view of a printing process according to an ink jet recording system showing a state that a leading end of a recording sheet is being printed;

FIG. 1(B) is a schematic perspective view of the printing process according to the ink jet recording system showing a state that a side edge of the recording sheet is being printed;

FIG. 1(C) is a schematic perspective view of the printing process according to the ink jet recording system showing a state that a trailing end of the recording sheet is being printed;

FIG. 2 is a side view of the printing process shown in FIG. 1(A);

FIG. 3 is a perspective view of an ink jet printing apparatus showing a printing mechanism;

FIG. 4 is a partial plan view of the ink jet printing apparatus shown in FIG. 3 showing the printing mechanism;

FIG. 5 is a partial section view of the ink jet printing apparatus shown in FIG. 3 showing the printing mechanism;

FIG. 6 is a schematic plan view of a related-art supporting plate;

FIG. 7 is a schematic perspective view separately showing the related-art supporting plate shown in FIG. 6 and an ink receiving member;

FIG. 8 is a section view along the line VIII-VIII shown in FIG. 7 showing the state that the ink receiving member is accommodated in the supporting plate shown in FIG. 7 and the recording sheet;

FIG. 9 is a schematic view for explaining a narrow angle;

FIG. 10 is a schematic view for explaining an arc in which a tangential line is circumscribed;

FIG. 11 is a schematic view for explaining a complex shape;

FIG. 12 is a partial perspective view of a projection according to a first embodiment of the invention;

FIG. 13 is a partial perspective view of a projection according to a second embodiment of the invention;

FIG. 14 is a partial perspective view of a projection according to a third embodiment of the invention;

FIG. 15 is a partial perspective view of a projection according to a fourth embodiment of the invention;

FIG. 16 is a partial perspective view of a projection according to a fifth embodiment of the invention;

FIG. 17 is a partial perspective view of a projection according to a sixth embodiment of the invention;

FIG. 18 is a partial perspective view of a projection according to a seventh embodiment of the invention;

FIG. 19 is a partial perspective view of a recess according to an eighth embodiment of the invention; and

FIG. 20 is a partial perspective view of a recess according to a ninth embodiment of the invention.

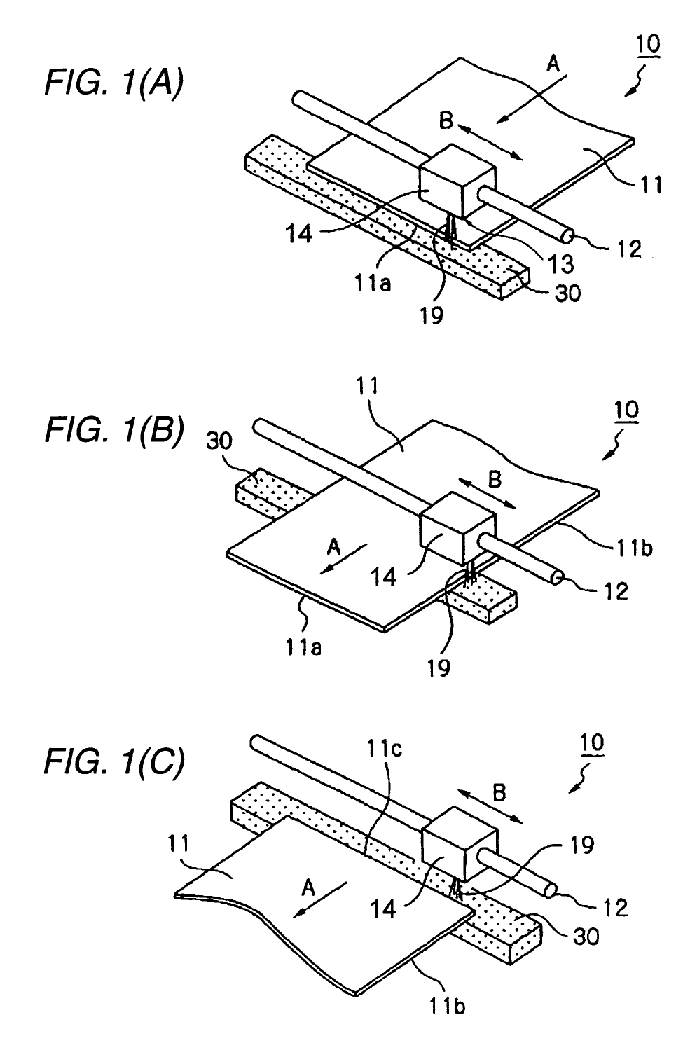

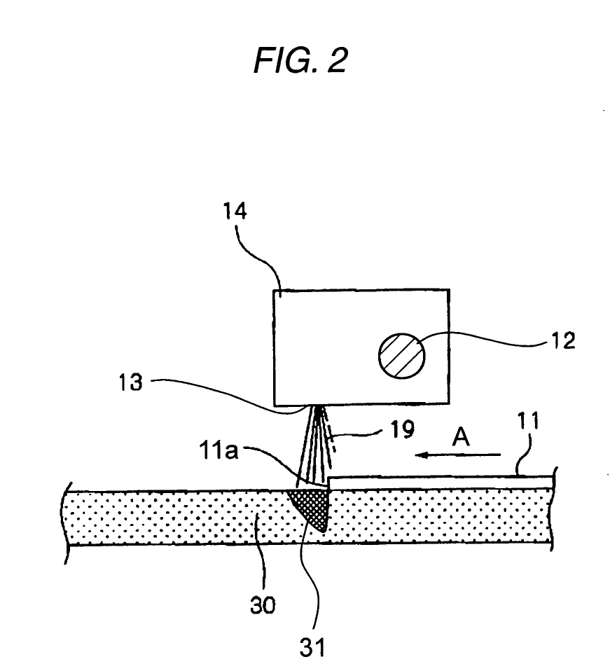

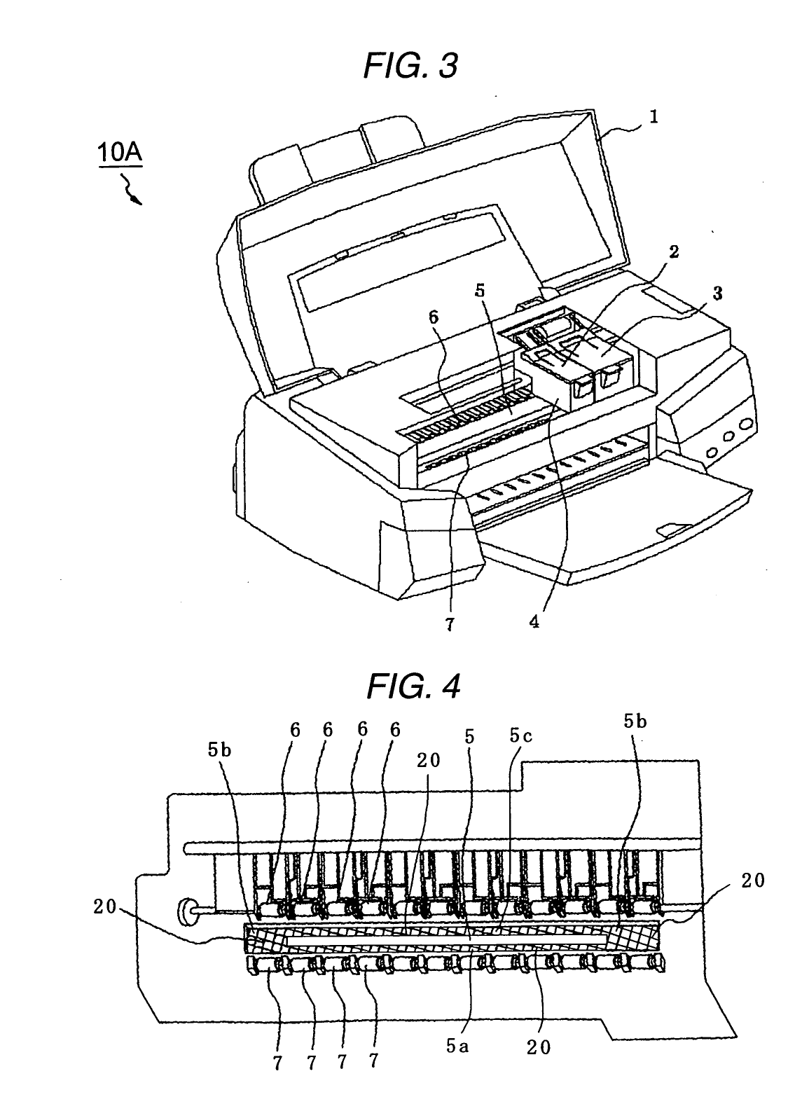

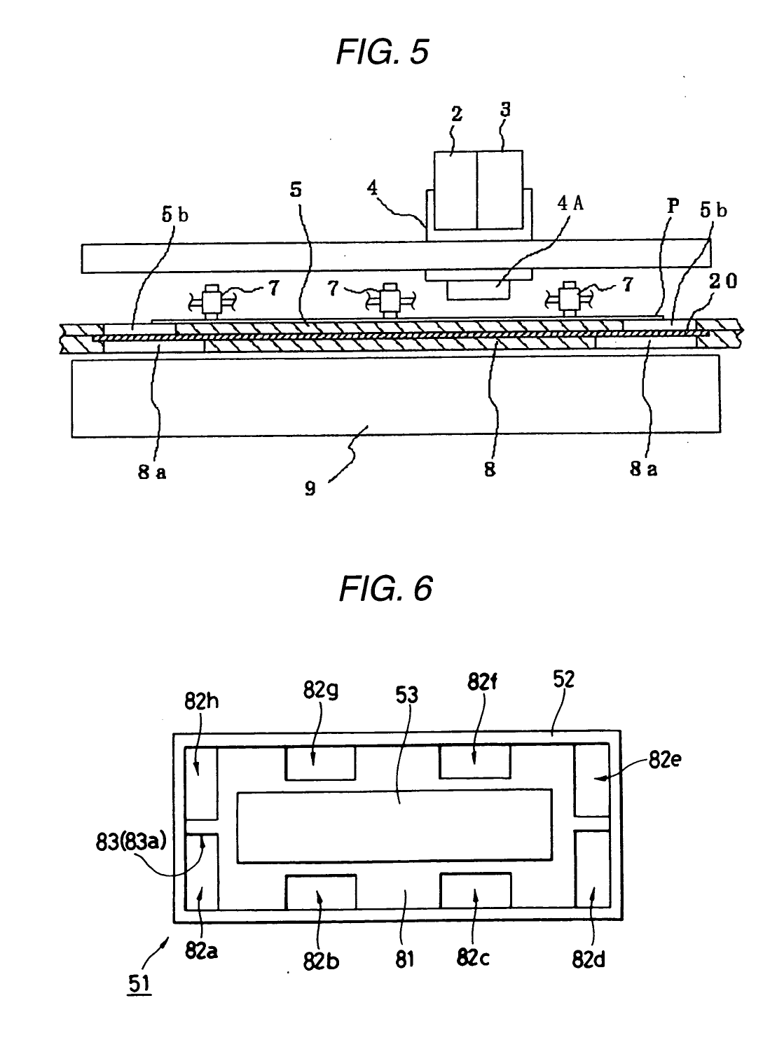

### DETAILED DESCRIPTION OF THE EMBODIMENTS

Embodiments of the invention will be described below in detail with reference to the accompanying drawings.

According to the invention, at least one of a projection and a recess is formed on the inner face of the respective through holes.

As shown in FIGS. 6 to 8, a cross-sectional shape (in the direction in parallel to the upper face or lower face of the bottom wall) of each of the through holes 82 is a rectangle. However, the above cross-sectional shape of the through hole is not limited thereto as discussed below.

In this specification, unless otherwise noted, the cross-sectional shape of the through hole represents a cross-sectional shape in the direction in parallel to the upper face and lower face of the supporting plate 51. In the supporting plate, the cross-sectional shape of the through hole may be:

(1) a polygon in which all internal angles are narrow angles (hereinafter referred to as a narrow-angle polygon);

(2) a curved figure which is a set of arcs in which all tangential lines are circumscribed (hereinafter referred to as a circumscribed curved figure); or

(3) a complex form which is a combination of a part of the polygon identified in the above item (1) and a part of the curved figure identified in the above item (2) (hereinafter simply referred to as a complex form).

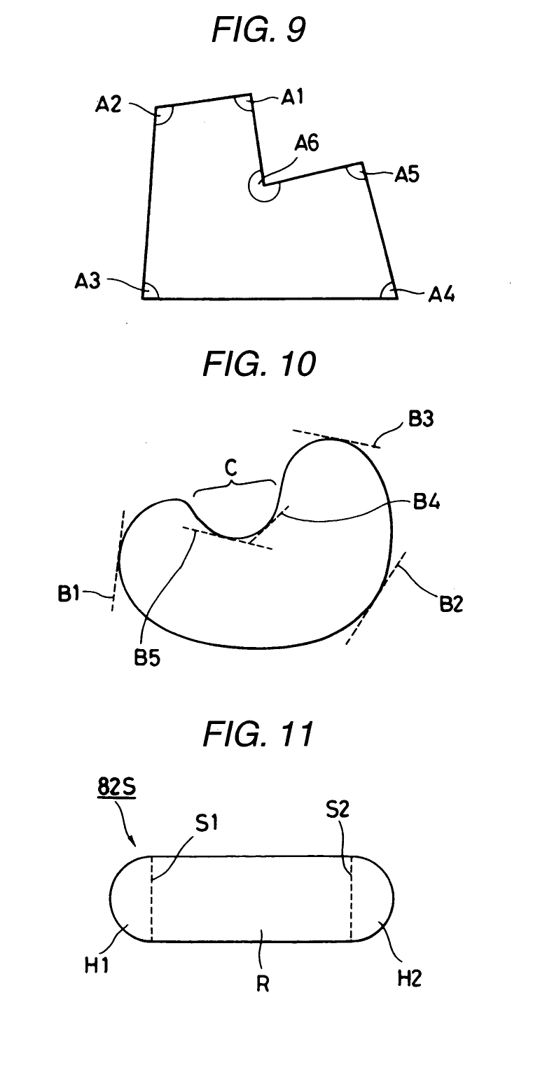

In this specification, the “narrow angle” represents the angle that is larger than 0° and smaller than 180°. Therefore, in a hexagon shown in FIG. 9 for example, the internal angle that is the narrow angle corresponds to the angles A1 to A5. Angle A6 that exceeds 180° does not correspond to the internal angle that is the narrow angle. The shape of the polygonal through hole is not particularly limited to the narrow-angle polygon, but may be a quadrangle, a rectangle or square.

In this specification, in the curved figure shown in FIG. 10 for example, the arcs having tangential line B1 to B3 correspond to the “arcs in which the tangential lines are circumscribed”, whereas the arc having the tangential lines B4 and B5 does not correspond to the “arc in which the tangential lines are circumscribed”. Therefore, in this specification, the “set of arcs in which all the tangential lines are circumscribed” represents a circular figure which comprises only the arcs having the tangential lines B1 to B3 but does not includes the arc having the tangential lines B4 and B5.

In the circumscribed curved figure through hole of the supporting plate, the circumscribed curved figure is not particularly limited, but may be an ellipse or circle.

In the complex through hole of the supporting plate, the complex form is not particularly limited, but a combined FIG. 82s comprising a rectangle R and two semi-circles H1, H2 integrated to the short sides S1, S2 of the rectangle R (see FIG. 11).

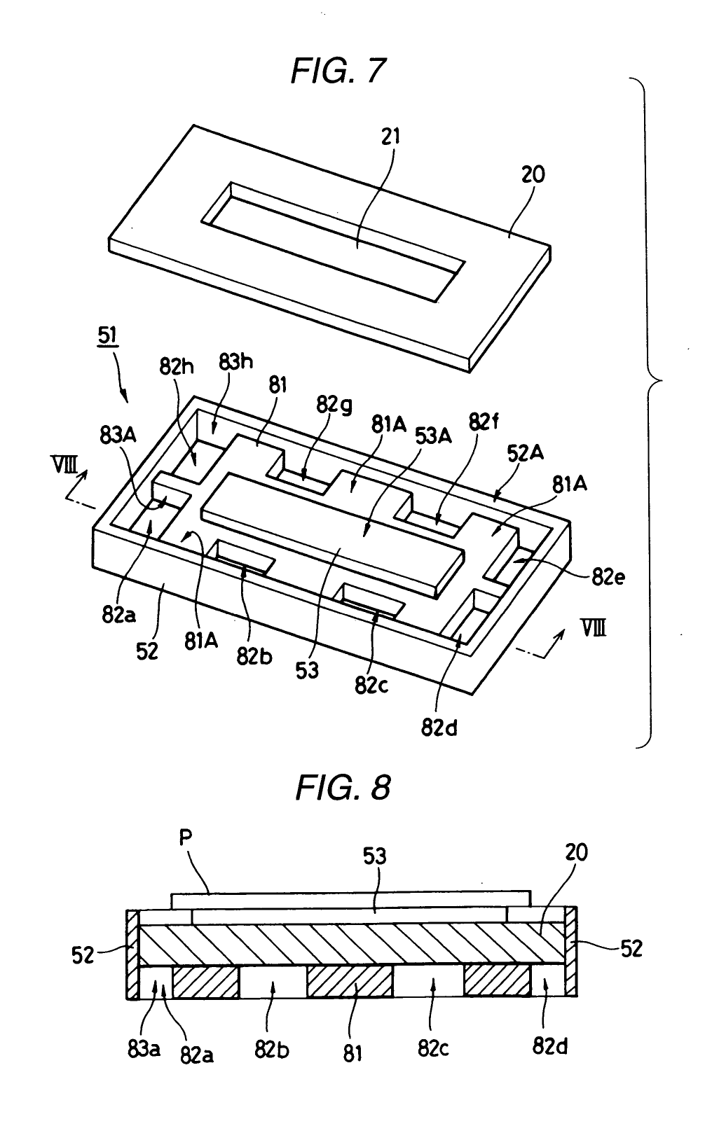

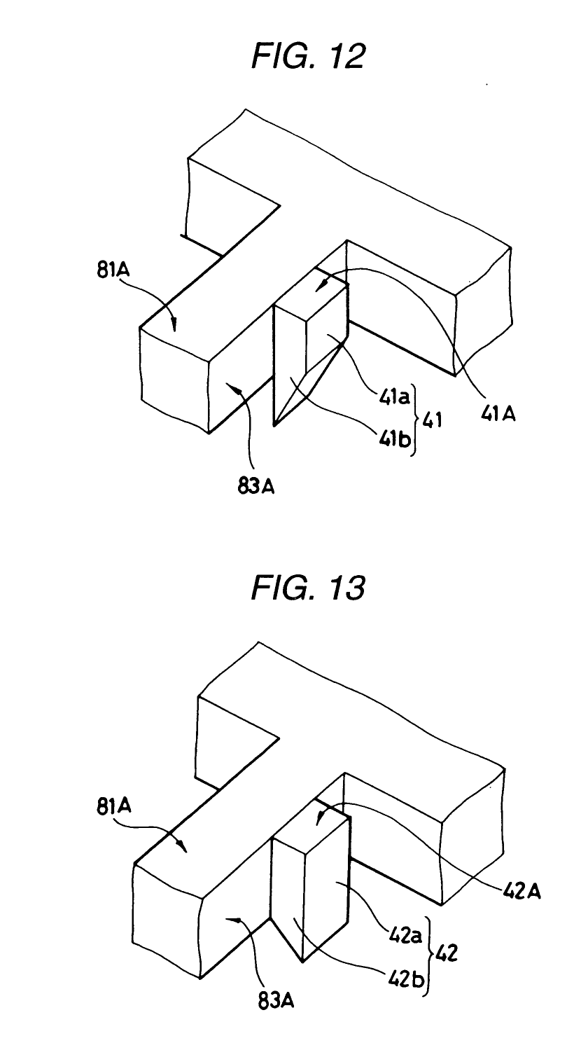

As shown in FIG. 12, according to a first embodiment of the invention, a projection 41 is formed on the inner face 83A (see FIG. 7) of the rectangular through-hole 82a. The projection 41 includes a square pillar body 41a and a sharpened end portion 41b. The sharpened end portion 41b is formed so as to be closer to the inner face 83A. An upper face 41A of the projection 41 is made flush with the upper face 81A of the bottom wall 81 (see FIG. 7). Therefore, in the case where the ink receiving member 20 is accommodated in the supporting plate 51, the upper face 41A of the projection 41 is brought into contact with the back face of the ink receiving member 20.

Next, a second embodiment of the invention will be described. Components similar to those in the first embodiment will be designated by the same reference numerals and repetitive explanations for those will be omitted. As shown in FIG. 13, in this embodiment, a projection 42 is formed on the inner wall 83A. The projection 42 includes a square pillar body 42a and a sharpened end portion 42b. In the second embodiment, the sharpened end portion 42b is formed so as to be farther from the inner face 83A. An upper face 42A of the projection 42 is made flush with the upper face 81A of the bottom wall 81. In the case where the ink receiving member 20 is accommodated in the supporting plate 51, the upper face 42A is brought into contact with the back face of the ink receiving member 20.

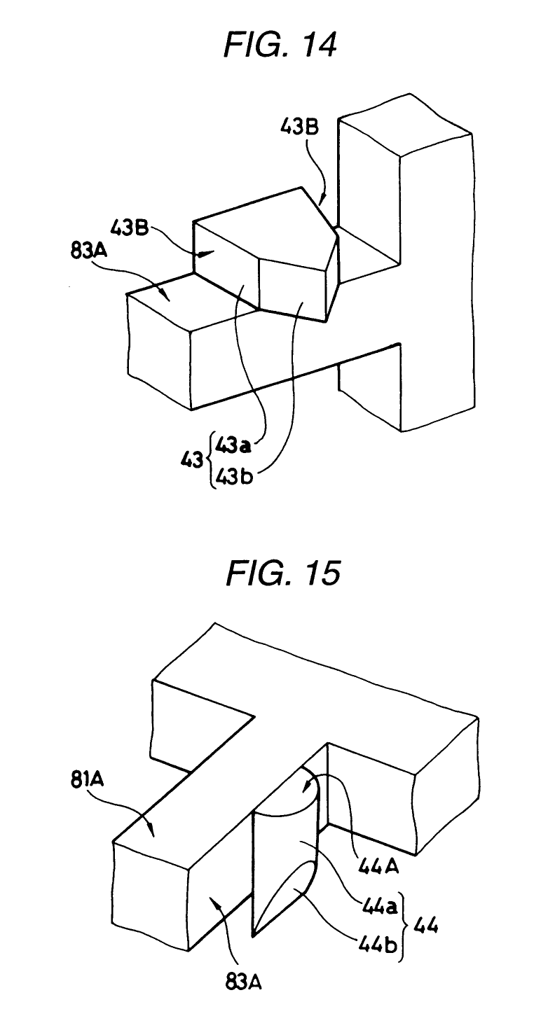

Next, a third embodiment of the invention will be described. Components similar to those in the first embodiment will be designated by the same reference numerals and repetitive explanations for those will be omitted. As shown in FIG. 14, in this embodiment, the projection 43 is formed on the inner wall 83A. The projection 43 includes a square pillar body 43a and a sharpened end portion 43b. The sharpened end portion 43b is formed on the bottom of the square pillar with a triangle pillar shape. The square pillar body 43a has a shape in which the interval between a pair of opposite sides 43B, 43B is gradually narrowed from the upper end side toward the lower end side.

Next, a fourth embodiment of the invention will be described. Components similar to those in the first embodiment will be designated by the same reference numerals and repetitive explanations for those will be omitted. As shown in FIG. 15, in this embodiment, a pillar projection 44 is formed on the inner wall 83A. The pillar projection 44 includes a semi-circular pillar top 44a and a sharpened end portion 44b. An upper face 44A of the projection 44 is made flush with the upper face 81A of the bottom wall 81 (see FIG. 7). In the case where the ink receiving member 20 is accommodated in the supporting plate 51, the upper face 44A of the projection 44 is brought into contact with the back face of the ink receiving member 20.

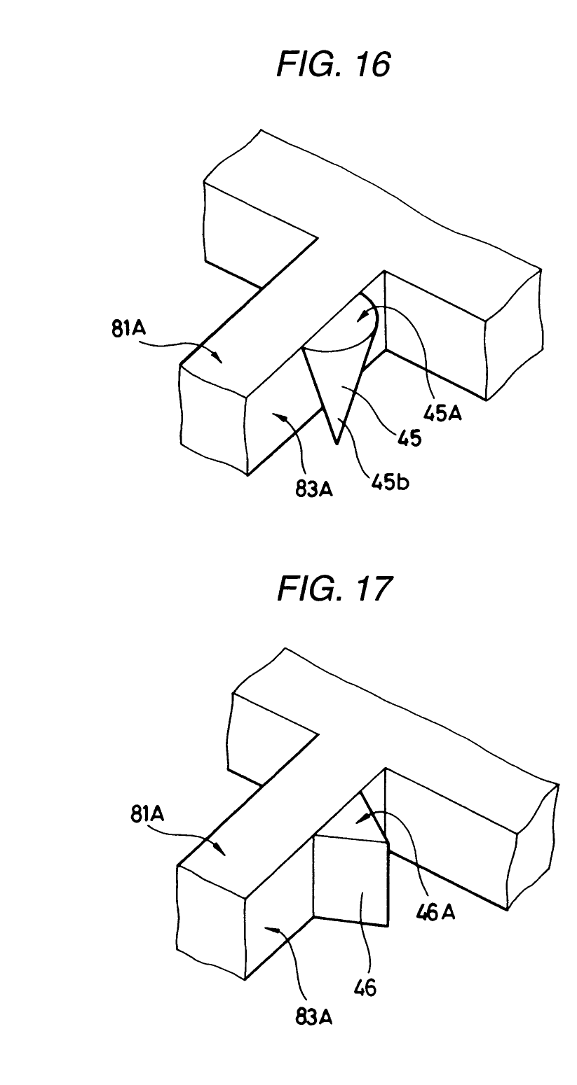

Next, a fifth embodiment of the invention will be described. Components similar to those in the first embodiment will be designated by the same reference numerals and repetitive explanations for those will be omitted. As shown in FIG. 16, in this embodiment, a projection 45 is formed on the inner wall 83A. The projection 45 has a sharpened end portion 45b. An apex of the sharpened end portion 45b is directed downward. An upper face 45A of the projection 45 is made flush with the upper face 81A of the bottom wall 81 (see FIG. 7). In the case where the ink receiving member 20 is accommodated in the supporting plate 51, the upper face 45A is brought into contact with the back face of the ink receiving member 20.

Next, a sixth embodiment of the invention will be described. Components similar to those in the first embodiment will be designated by the same reference numerals and repetitive explanations for those will be omitted. As shown in FIG. 17, in this embodiment, a projection 46 is formed on the inner wall 83A. An upper face 46A of the projection 46 is made flush with the upper face 81A of the bottom wall 81 (see FIG. 7). In the case where the ink receiving member 20 is accommodated in the supporting plate 51, the upper face 46A of the triangular projection 46 is brought into contact with the back face of the ink receiving member 20.

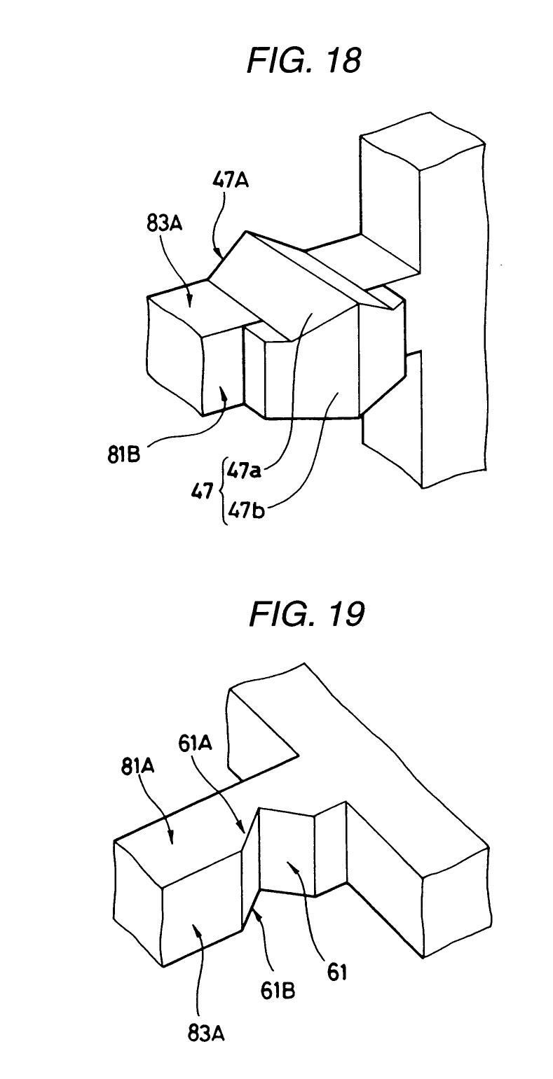

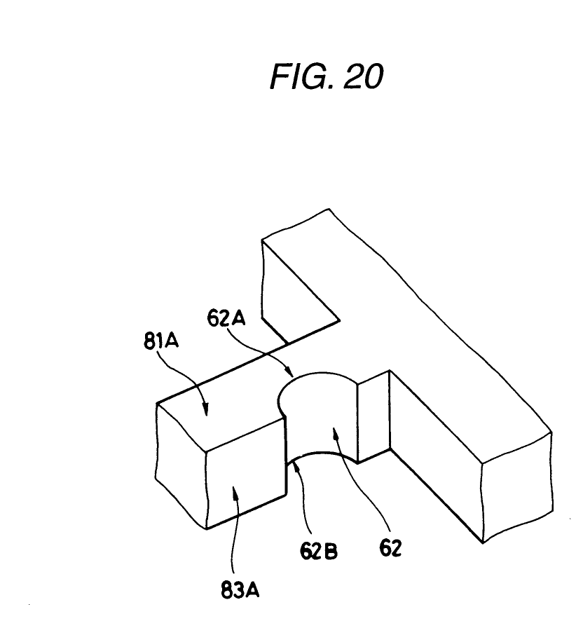

Next, a seventh embodiment of the invention will be described. Components similar to those in the sixth embodiment will be designated by the same reference numerals and repetitive explanations for those will be omitted. As shown in FIG. 18, in this embodiment, a projection 47 is formed on the inner wall 83A. The projection 47 has a triangular pillar body 47a and a sharpened end portion 47b. The sharpened end portion 47b is formed so as to project downward from the lower face 81B of the bottom wall 81. An upper face 41A of the projection 47 is made flush with the upper face 81A of the bottom wall 81 (see FIG. 7). In the case where the ink receiving member 20 is accommodated in the supporting plate 51, the upper face 47A of the projection 47 is brought into contact with the back face of the ink receiving member 20.

Next, an eighth embodiment of the invention will be described. Components similar to those in the first embodiment will be designated by the same reference numerals and repetitive explanations for those will be omitted. As shown in FIG. 19, in this embodiment, a V-shaped recess 61 is formed on the inner wall 83A. A cross-sectional shape of the recess 61 is V-shaped. An upper end 61A of the recess 61 is made flush with the upper face 81A of the bottom wall 81 (see FIG. 7). A lower end 61B of the recess 61 is made flush with the lower face of the supporting plate. The cross-sectional shape of the recess 61 is not changed from the upper end 61A toward the lower end 61B. In the case where the ink receiving member 20 is accommodated in the supporting plate 51, the upper end 61A of the recess 61 is brought into contact with the back face of the ink receiving member 20. The cross-sectional shape of the recess may be gradually changed from the upper end 61A toward the lower end 61B.

Next, a ninth embodiment of the invention will be described. Components similar to those in the eighth embodiment will be designated by the same reference numerals and repetitive explanations for those will be omitted. As shown in FIG. 18, in this embodiment, a recess 62 is formed on the inner wall 83A. A cross-sectional shape of the recess 62 is semi-circular. An upper end 62A of the recess 62 is made flush with the upper face 81A of the bottom wall 81 (see FIG. 7). A lower end 62B of the recess 62 is made flush with the lower face of the supporting plate. The cross-sectional shape of the recess 62 is not changed from the upper end 62A toward the lower end 62B. In the case where the ink receiving member 20 is accommodated in the supporting plate 51, the upper end 62A of the recess 62 is brought into contact with the back face of the ink receiving member 20. The cross-sectional shape of the recess 62 may be gradually changed from the upper end 62A toward the lower end 62B.

The projections and recesses described the above were subjected to a test confirming whether the ink temporarily trapped in the porous ink receiving member is smoothly transferred from the through holes into the waste ink tank so that the overflow of the ink from the ink receiving member. In a case where the projection or the recess was not formed in the through hole and water-based pigment ink is used, replacement of the ink receiving member was required after a few hundreds of pages of printing were performed. On the other hand, in a case where the projection or the recess was formed in the through hole and water-based pigment ink is used, replacement of the ink receiving member was required after a few thousands of pages of printing were performed. Meanwhile, the ink is transferred more smoothly into the waste ink tank in a case where the projection was formed in the through hole than in a case where the recess was formed therein.

In the above embodiments, the cross-sectional shape of the upper face of the projection or the upper end of the recess capable of being formed in the through hole may be a triangle, quadrangle (particularly, rectangle or square), a semi-circle, or a semi-ellipse.

In the above embodiments, the projection includes an upper body and a sharpened lower end portion, or solely includes an upper body. On the inner face of the through hole, the lower end may be made flush with or projected from the lower face of the supporting plate. Otherwise, the projection may be terminated at -the mid point on the inner face 83A.

In the above embodiments, the recess is formed on the inner face of the through hole so as to connect the upper end to the lower end of the recess. Otherwise, the recess may be formed from the upper end to the mid point not reaching the lower end.

In the above embodiments, at least one of the projection and the recess may be provided with each of the through holes. For example, in a case where one of the inner face 83A of the rectangular through hole 82a has a size of 1 cm to 2 cm, it is enough to provide only one projection (upper face: 0.5 cm×0.5 cm) as shown in FIG. 13 to obtain the sufficient ink transferring ability.

In the specification, the “ink receiving member” is used to trap directly ink drops ejected from the recording head to the area other than the recording sheet. For the same purpose, such a related-art ink receiving member is used in the printer being called “an ink absorbing material”. The “area other than the recording sheet” represents any area other than the surface of the recording sheet to which the ink drops are ejected. It is an outside area adjacent to the edge of the recording sheet during the marginless printing, and it includes an area at which a flushing operation of the recording head is performed. The flushing operation is performed by forcibly ejecting an ink composition from the recording head at a predetermined flushing position to which the recording sheet is not transported so as to prevent defective ejection from the recording head. The ink receiving member may be disposed at the flushing position.

The ink receiving member used in the invention, like the related-art ink receiving member, must receive the ink drops ejected from the ink head and completely trap them. For example, during the marginless printing, if the ink drops ejected to the outside region of the recoding sheet float in a misty state at the edge of the recording sheet without being completely trapped, they may contaminate the recorded image or recording sheet, and the surface being in contact with of the platen. Further, the ink receiving member may have a holding capability enough to trap the ink therein to prevent the leakage of the ink even when the printer is inclined owing to the change of a printer installing place while the ink is being trapped in the ink receiving member. Furthermore, the ink receiving member must sequentially transfers the trapped ink to the waste ink tank and trapping the subsequent ink drops so as to keep the holding capability.

The ink receiving member used in the invention may be comprised of any material having the above capabilities. The ink receiving member may be comprised of-a continuous porous material with individual pores being communicated.

The porous material, for example, may be a plastic foaming sheet or perforated sheet, or a fabric sheet (for example, web, mesh, woven-cloth, braid or no-woven cloth). The plastic form, for example, may be e.g. polyurethane foam, polyvinyl alcohol (PVA) sponge, or porous fluororesin porous medium.

The ink receiving member used in the invention may be constructed of a single layer structure or a two or more multiple layer structure. Where the ink receiving member includes two layers, it may include an ink receiving layer and an ink diffusing layer. The ink receiving layer serves to directly receive and to trap the ink drops ejected from the recording head. The ink diffusing layer serves to hold the ink trapped in the ink receiving layer and also to transfer it to the waste ink tank. The ink receiving layer and ink diffusing layer may be kept at least partially in contact with each other and the ink diffusing layer is comprised of a material with higher ink absorbency than that of the ink receiving layer. Further, these ink receiving layer and ink diffusing layer may be constructed of a two or more multiple layer structure, respectively.

The combination of the ink receiving layer and the ink diffusing layer, for example may be a combination of a mesh sheet of high polymer compound (fluororesin) and a porous sheet of hydrophilic high polymer compound, or a combination of a polyurethane foam sheet and a PVA sponge sheet.

The combination of the polyurethane foam sheet and the PVA sponge sheet may be used. By providing the PVA sponge sheet with a higher density than that of the polyurethane in a range larger than at least the printing region of the ink jet head, the entire ink received in the polyurethane foam can be swiftly transferred to the PVA sponge sheet of the ink diffusing layer. Specifically, since the polyurethane foam transfers the ink in the gravity direction, if the PVA sponge sheet is provided in the range larger than a region where the ink is transferred, the ink received in the polyurethane foam can be effectively transferred into the PVA sponge provided below the polyurethane foam. Farther, because of the holding capability of the PVA sponge sheet, the leakage of the ink when the printer is inclined can be easily prevented.

The ink trapped in the ink receiving member as described above passes through the PVA sponge sheet of the diffusing layer and is swiftly ejected into the waste ink tank through the projections or recesses formed in the through holes.

The ink jet printer used in the invention is not particularly limited, if the ink receiving member can be disposed in the ink jet printer. Therefore, an ordinary printer can be used as it is. The kind of the ink jet recording system is not also limited. The ink jet recording system can be applied to a device for jetting liquid drops by driving a piezo vibrator using a recording signal or a device for applying thermal energy corresponding to the recording signal to liquid within a pressure generating chamber, thereby generating the liquid drops owing to the energy.

The supporting plate according to the invention can be used as a plate for accommodating and supporting the ink receiving member for directly trapping the ink drops ejected to the area other than the recording sheet. Since the ink trapped in the ink receiving member can be smoothly transferred into the waste ink tank, the ink receiving member can be used for a long time.

What is claimed is:

1. A plate member formed with a through hole comprising:
a first face adapted to support an ink receiving member thereon; and
at least one of a projection and a recess formed on an inner face of the through hole such that a first end thereof is made flush with the first face.

2. The plate member as set forth in claim 1, wherein a cross-sectional shape of the through hole in a direction parallel to the first face is one of:
(1) a polygon which all of internal angles are narrow angles;
(2) a curved figure which is a set of arcs in which all of tangential lines are circumscribed; and
(3) a complex form which is a combination of a part of the polygon identified in item (1) and a part of the curved figure identified in item (2).

3. The plate member as set forth in claim 1, wherein a cross-sectional shape of the first end in a direction parallel to the first face is one of a triangle, a quadrangle, a semi-circle and a semi-ellipse.

4. The plate member as set forth in claim 1, further comprising:
a second face which is opposite to the first face,
wherein a second end of the projection is sharpened at the vicinity of the second face.

5. The plate member as set forth in claim 4, wherein the second end is projected from the second face.

6. The plate member as set forth in claim 1, further comprising:
a second face which is opposite to the first face,
wherein the recess connects the first face and the second face.

7. The plate member as set forth in claim 2, wherein the polygon is a rectangle.

8. The plate member as set forth in claim 2, wherein the curved figure is an ellipse.

9. The plate member as set forth in claim 2, wherein the complex form is a combined figure comprising a rectangle and two semi-circles integrated to short sides of the rectangle.

10. A recording apparatus comprising:
a plate member formed with a through hole;
at least one of a projection and a recess formed on an inner face of the through hole such that a first end thereof is made flush with a first face of the plate member;
a recording head operable to eject ink; and
an ink receiving member adapted to receive the ink and supported by the first face of the plate member, the ink receiving member comprising a first layer having a first absorbency and a second layer which is being in contact with the first layer and having a second absorbency higher than the first absorbency.

11. The recording apparatus as set forth in claim 10, wherein the ink is pigment ink.
